(19) United States
(12) Patent Application Publication
(10) Pub. No.: US 2026/0099460 A1
(43) Pub. Date: Apr. 9, 2026

(54) PERFORMANCE OPTIMIZATION IN MULTI-DOMAIN SYSTEMS ON CHIPS THAT SHARE A POWER SUPPLY

(71) Applicant: QUALCOMM Incorporated, San Diego, CA (US)

(72) Inventors: Dinesh Kumar Choudhary, Tonk (IN); Sai Sneha Venkata Yesantarao, Hyderabad (IN); Raja Simha Revanuru, Hyderabad (IN)

(21) Appl. No.: 18/906,510

(22) Filed: Oct. 4, 2024

(51) Int. Cl. G06F 15/78; G06F 1/324; G06F 1/3296

(52) U.S. Cl. CPC G06F 15/7807; G06F 1/324; G06F 1/3296

(57) ABSTRACT

A system-on-chip (SoC) performance management technique is described for designs with multiple clock domains sharing a power supply. The technique involves a shared rail boost (SRB) feature that adjusts performance states across different clock domains. The SRB feature is enabled based on conditions such as utilization levels, active core counts, or voltage differences between domains. When enabled, the SRB feature allows assignment of a higher performance state to a clock domain. The technique compares open-loop voltages between domains and aggregates target and recommended performance states to determine final states. It includes mechanisms for disabling the SRB feature under certain conditions and considers the performance states of other clock domains. The approach operates independently of schedulers or kernels, allowing for integration into various SoC designs.

### TECHNICAL FIELD

This disclosure relates generally to semiconductor device performance, and more specifically, to performance optimization techniques for system-on-chip (SoC) designs incorporating multiple clock domains that share a power supply.

### DESCRIPTION OF THE RELATED TECHNOLOGY

Modern system-on-chip (SoC) designs have become increasingly complex and may incorporate multiple clock domains to support various functionalities and performance requirements. These multi-domain SoCs may share power supplies across different cores or clusters to optimize design aspects such as cost, power grid layout, and limitations. While a shared power supply approach offers certain advantages, it also presents challenges in terms of performance management and power efficiency.

In typical SoC designs, power supplies are calibrated based on silicon characteristics to ensure sustainable operation when all shared components are running at peak performance. However, the actual output at the power supply is an aggregate of all currently active shared components. Aggregation can result in scenarios where different clock domains operate at the same voltage level but at varying frequencies, leading to potential inefficiencies.

Dynamic Clock and Voltage Scaling (DCVS) algorithms, which are sometimes utilized to manage power and performance in SoCs, often operate independently within individual frequency domains. Such algorithms, whether running in high-level operating systems or firmware, are generally unaware of characteristics of the shared power supply. The lack of awareness can result in suboptimal power and performance management by, e.g., hindering data transfer rates and processing speeds across different domains.

Furthermore, the interaction between multiple clock domains sharing a power supply can lead to complex thermal management issues. Sustained high-performance operation in one domain may impact the thermal conditions of other domains, potentially affecting overall system stability and longevity.

As SoC designs continue to evolve and incorporate more diverse and specialized processing units, the challenge of efficiently managing performance and power across multiple domains with shared resources becomes increasingly critical. Addressing such challenges requires approaches that can optimize performance states across different clock domains while considering characteristics of the shared power supply and the varying demands of different processing units.

### SUMMARY

The systems, methods and devices of this disclosure each have several innovative aspects, no single one of which is solely responsible for the desirable attributes disclosed herein. Exemplary aspects of the disclosure are directed to performance optimization techniques for system-on-chip (SoC) designs incorporating multiple clock domains that share a power supply.

One innovative aspect of the subject matter described in this disclosure can be implemented in a system-on-chip (SoC) with multiple clock domains. The SoC includes a processing system configured to receive an indication of a target performance state of a first clock domain associated with a first performance state. The processing system enables a shared rail boost (SRB) feature for the first clock domain if at least one of: a utilization level of the first clock domain exceeds a first threshold, a number of active cores in the first clock domain exceeds a second threshold, or a voltage difference between the first clock domain and at least one other clock domain, or between the first performance state and at least one other performance state, is in a range. If the SRB feature is enabled, the processing system assigns a second performance state to the first clock domain, wherein the second performance state is associated with the target performance state. If the SRB feature is not enabled, the processing system assigns the first performance state to the first clock domain.

In some examples, the processing system compares an open-loop voltage of the first clock domain with an open-loop voltage of the at least one other clock domain and selects a recommended performance state based on the comparison. The recommended performance state may comprise a higher performance state for the clock domain with the lower open-loop voltage. The processing system may aggregate the target performance state and the recommended performance state to determine the second performance state.

In some implementations, the processing system disables the SRB feature if the first clock domain is at a workload lower than a threshold workload, or if a temperature of the first clock domain exceeds a temperature threshold. The receiving and enabling operations may be agnostic to schedulers or kernels. The second performance state may be associated with an input from a Frequency Vote Aggregator (FVA), the recommended performance state, or a hardware constraint.

In certain examples, when enabling the SRB feature, the processing system identifies the number of active cores in the first clock domain as greater than one and does not enable the SRB feature for the last active core. The processing system may also determine that a performance state of the at least one other clock domain is above a threshold and enable the SRB feature if this condition is met.

Another innovative aspect of the subject matter described in this disclosure can be implemented in a method for managing performance in a system-on-chip (SoC) having multiple clock domains. The method includes receiving a vote for a target performance state of a first clock domain associated with a first performance state, enabling a shared rail boost (SRB) feature based on specific conditions, and assigning performance states based on whether the SRB feature is enabled.

In some examples, the method includes comparing open-loop voltages between clock domains, selecting recommended performance states, and aggregating target and recommended performance states. The method may also involve disabling the SRB feature under certain conditions and considering performance states of other clock domains when enabling the SRB feature.

A further innovative aspect of the subject matter described in this disclosure can be implemented in an apparatus for managing performance in a system-on-chip (SoC) having more than one clock domain. The apparatus includes a processing system configured to monitor performance states of multiple clock domains sharing a power supply, enable a shared rail boost (SRB) feature based on specific conditions, and adjust the performance state of the first clock domain based on the enabled SRB feature and the performance state of other clock domains.

In some examples, the apparatus compares open-loop voltages between clock domains and selects performance states above a threshold for domains with lower open-loop voltages. The apparatus may disable the SRB feature when a temperature threshold is exceeded, regardless of other enabling conditions. The performance state adjustment may involve selecting target and recommended performance states and aggregating them to determine an adjusted performance state.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

The integrated circuits and System on Chips (SoCs) described herein may be used for processing of various kinds of data, including audio signal processing, video processing, artificial intelligence (AI) processing, mathematical computations, database processing, image processing, and other kinds of data processing. These integrated circuits and/or SoCs can be incorporated into a wide variety of devices. By way of example, they may be incorporated into stand-alone audio devices, such as entertainment devices and personal media players, wireless communication device handsets such as mobile telephones, cellular or satellite radio telephones, personal digital assistants (PDAs), tablets, gaming devices, computing devices such as webcams, video surveillance cameras, or other devices that process data using processing circuitry (e.g., application specific integrated circuits (ASICs), digital signal processors (DSP), graphics processing unit (GPU), or central processing units (CPU)).

In some aspects, a device may include a digital signal processor or a processor (e.g., an application processor) including specific functionality for data processing. Operations on different kinds of data may be performed by different processors, or various operations may be split between the various data processing circuitry (e.g., ASICs, DSP, GPU, CPU, NPU). In some embodiments, the methods and techniques disclosed herein may be adapted for use in a neural signal processor (NSP) in which one or more parameters of data processing are controlled based on output from a machine learning (ML) model executed by the NSP.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos (with associated or embedded sounds) in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows processing system 100 which may be a system on chip (SoC) according to certain aspects.

FIG. 2 shows a flowchart illustrating an example process 400 performable by or at an apparatus that supports dynamic performance management in system-on-chip (SoC) designs with multiple clock domains according to certain aspects.

FIG. 3 is a block diagram of an example system-on-chip (SoC) apparatus 500 that supports dynamic performance management across multiple clock domains according to certain aspects.

FIG. 4 shows a flowchart illustrating an example process 600 for dynamic performance management in system-on-chip (SoC) designs with multiple clock domains sharing a power supply according to certain aspects.

FIG. 5 is a block diagram of an example system-on-chip (SoC) apparatus 700 that supports dynamic performance management across multiple clock domains sharing a power supply according to certain aspects.

FIG. 6 illustrates a block diagram of exemplary finite state machine (FSM) logic 800 for dynamic performance management in a system-on-chip (SoC) with multiple clock domains sharing a power supply according to certain aspects.

Like reference numbers and designations in the various drawings indicate like elements.

### DETAILED DESCRIPTION

Aspects of this disclosure relate to system-on-chip (SoC) designs that incorporate multiple clock domains that share a power supply. Disclosed aspects address challenges relating to performance management and power efficiency using a shared rail boost (SRB) feature that dynamically adjusts performance states across different clock domains. Doing so may further involve monitoring utilization levels, active core counts, and/or voltage differences to determine when to enable the SRB feature.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

Particular implementations of the subject matter described in this disclosure may be implemented to realize one or more of the following potential advantages or benefits. In some aspects, the present disclosure provides techniques for receiving votes for target performance states in various clock domains. When enabled, a SRB feature allows assignment of higher performance states according to one or more received votes. Some implementations compare open-loop voltages between clock domains and select recommended performance states based on the comparisons. Final performance states may be determined by aggregating target and recommended states, balancing software requests with hardware recommendations. The foregoing aspects can be implemented independently of schedulers or kernels, allowing for integration into various SoC designs and operating systems.

The SRB feature can be disabled when a clock domain experiences low workload or exceeds temperature thresholds. These techniques also consider the last active core in a domain, which can help avoid unnecessary power consumption in certain scenarios. Additionally, the performance states of other clock domains are taken into account when enabling the SRB feature. In some implementations, performance state adjustments can be influenced by inputs from a Frequency Vote Aggregator (FVA), recommended states, or hardware constraints.

Certain aspects can enable the SRB feature based on active core count, utilization levels, or voltage differences between domains. Performance states are then adjusted based on the enabled SRB feature and the states of other clock domains, This provides dynamic optimization of system performance and power consumption. By dynamically adjusting performance states across multiple clock domains, implementations can optimize performance without excessive power consumption. Devices incorporating these aspects can exhibit improved battery life or reduced energy consumption.

The use of specific thresholds and conditions for enabling the SRB feature allows implementations to make informed decisions. Performance boosts can be provided when needed while avoiding unnecessary power consumption during light workloads. This approach results in system operation that adapts to varying computational demands. By fine-tuning performance based on current needs, implementaitons can maintain responsiveness while conserving power during periods of lower activity.

Comparing open-loop voltages between clock domains informs decisions about performance boosts. By selecting higher performance states for domains with lower open-loop voltages, implementations can achieve performance improvements while minimizing additional power consumption. This contributes to efficient use of the shared power supply.

Temperature-based disabling of the SRB feature, as implemented in some aspects, serves as a thermal management mechanism. Mitigating potential issues arising from sustained high-performance operation improves durability of SoC devices. And the balance between performance and thermal management supports consistent operation across various conditions.

Some implementations involve special handling for the last active core in a domain. For instance, in adjusting the SRB feature’s behavior for the last active core, such implementations can fine-tune power consumption in low-activity scenarios to improve efficiency. This level of granularity in power management allows for optimized performance even as cores become inactive. Additional implementations that aggregate target and recommended performance states allow for a multi-faceted approach to performance management. By considering both software-requested performance levels and hardware-recommended states, such implementations can achieve an optimized final performance state. This approach aligns with system requirements and efficiency goals to ensure that performance is tailored to both application needs and hardware capabilities.

The detailed description set forth below, in connection with the appended drawings to which the text references, is intended as a description of various embodiments and is not intended to limit the scope of the disclosure. Rather, the detailed description includes specific details for the purpose of providing a thorough understanding of the subject matter of this disclosure. It will be apparent to those skilled in the art that these specific details are not required in every case and that, in some instances, well-known structures and components are shown in block diagram form for clarity of presentation.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

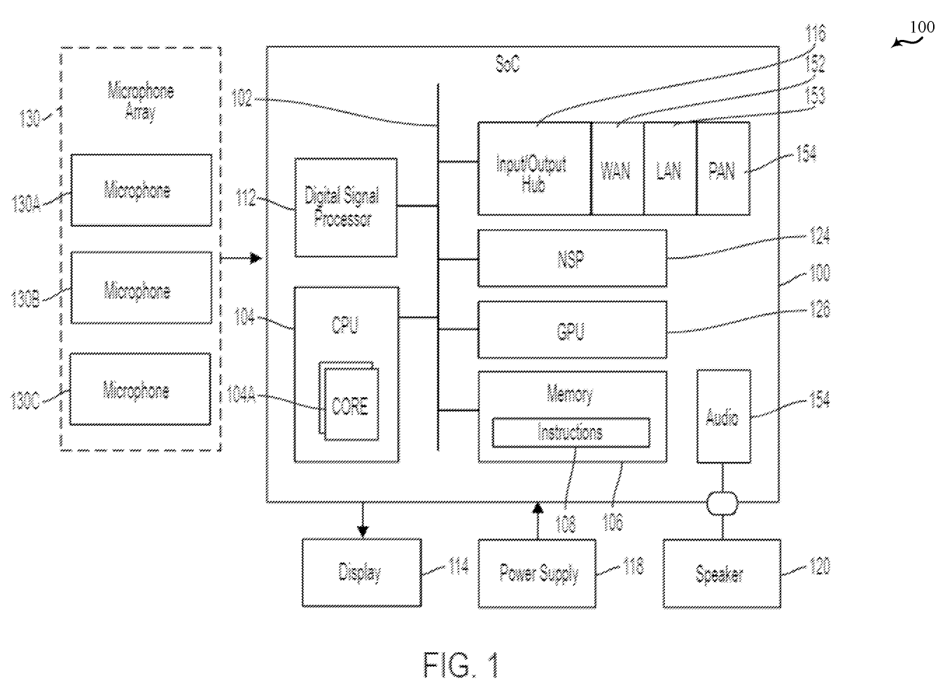

FIG. 1 shows a block diagram of a system-on-chip (SoC) configured for performing signal processing according to one or more aspects of this disclosure. The SoC 100 may include several components coupled together through a bus 102, which may be a network-on-a-chip (NoC) or a plurality of NOCs interconnecting various components. For example, although FIG. 1 illustrates several components coupled to the bus 102, the several components may be coupled to different busses with additional busses connecting the different busses to provide a path for communication between the components.

One example component in the SoC 100 is a digital signal processor 112 for signal processing. The DSP 112 may process audio signals received from microphones 130A, 130B, and 130C of microphone array 130. The DSP 112 may include hardware customized for performing a limited set of operations on specific kinds of data. For example, a DSP may include transistors coupled together to perform operations on streaming data and use memory architectures and/or access techniques to fetch multiple data or instructions concurrently. Such configurations may allow the DSP 112 to operate on real-time data, such as video data, audio data, or modem data, in a power-efficient manner.

The SoC 100 also includes a central processing unit (CPU) 104 and a memory 106 storing instructions 108 (e.g., a memory storing processor-readable code or a non-transitory computer-readable medium storing instructions) that may be executed by a processor of the SoC 100. The CPU 104 may be a single central processing unit (CPU) or a CPU cluster comprising two or more cores such as core 104A. The CPU 104 may include hardware capable of performing generic operations on many kinds of data, such as hardware capable of executing instructions from the Advanced RISC Machines (ARM®) instruction set, such as ARMv8 and ARMv9. For example, a CPU 104 may include transistors coupled together to perform operations for supporting executing an operating system and user applications (e.g., a camera application, a multimedia application, a gaming application, a productivity application, a messaging application, a videocall application, an audio recording application, a video recording application). The CPU 104 may execute instructions 108 retrieved from the memory 106. In some embodiments, the CPU 104 executing an operating system may coordinate execution of instructions by various components within the SoC 100. For example, the CPU 104 may retrieve instructions 108 from memory 106 and execute the instructions on the DSP 112.

The SoC 100 may further include a neural signal processor (NSP) 124 for executing machine learning (ML) models relating to multimedia applications. The NSP 124 may include hardware configured to perform and accelerate convolution operations involved in executing machine learning algorithms. For example, the NSP 124 may improve performance when executing predictive models such as artificial neural networks (ANNs) (including multilayer feedforward neural networks (MLFFNN), the recurrent neural networks (RNN), and/or the radial basis functions (RBF)). The ANN executed by the NSP 124 may access predefined training weights stored in the memory 106 for performing operations on user data.

The SoC 100 may be coupled to a display 114 for interacting with a user. The SoC 100 may also include a graphics processing unit (GPU) 126 for rendering images on the display 114. In some embodiments, the CPU 104 may perform rendering to the display 114 without a GPU 126. In some embodiments, the GPU 126 may be configured to execute instructions for performing operations unrelated to rendering images, such as for processing large volumes of datasets in parallel.

Processing algorithms, techniques, and methods may be executed by at least one processor of the SoC 100, which may include execution by all steps on one of the processors (e.g., DSP 112, CPU 104, NSP 124, GPU 126) or may include execution of steps across a combination of one or more of the processors (e.g., DSP 112, CPU 104, NSP 124, GPU 126). In some embodiments, at least one of the DSP 112 or the CPU 104 executes instructions to perform various operations described herein, including enabling an shared rail boost (SRB) feature. For example, execution of the instructions by the CPU 104 as part of a multimedia application (e.g., a voice recorder, a sound recording, or a video recorder) may instruct the DSP 112 to begin or end capturing audio from one or more microphones 130A-C. The operations of the CPU 104 may be based on user input. For example, a voice recorder application executing on processor 104 may receive a user command to begin a voice recording upon which audio comprising one or more channels is captured and processed for playback and/or storage. Audio processing to determine “output” or “corrected” signals, such as according to techniques described herein, may be applied to one or more segments of audio in the recording sequence.

Input/output components may be coupled to the SoC 100 through an input/output (I/O) hub 116. An example of a hub 116 is an interconnect to a peripheral component interconnect express (PCIe) bus. Example components coupled to hub 116 may be components used for interacting with a user, such as a touch screen interface and/or physical buttons. Some components coupled to hub 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna that may be shared by each of the adaptors 152, 153, and 154, or coupled to multiple antennas configured for primary and diversity reception and/or configured for receiving specific frequency bands. In some embodiments, the WAN adaptor 152, LAN adaptor 153, and/or PAN adaptor 154 may share circuitry, such as portions of a radio frequency front end (RFFE).

Audio circuitry 154 may be integrated in SoC 100 as dedicated circuitry for coupling the SoC 100 to a speaker 120 external to the SoC 100, which may be a transducer such as a speaker (either internal to or external to a device incorporating the SoC 100) or headphones. The audio circuitry 154 may include coder/decoder (CODEC) functionality for processing digital audio signals. The audio circuitry 154 may further include one or more amplifiers (e.g., a class-D amplifier) for driving a transducer coupled to the SoC 100 for outputting sounds generated during execution of applications by the SoC 100. Functionality related to audio signals described herein may be performed by a combination of the audio circuitry 154 and/or other processors of the SoC (e.g., CPU 104, DSP 112, GPU 126, NSP 124).

The SoC 100 may couple to external devices outside the package of the SoC 100. For example, the SoC 100 may be coupled to a power supply 118, such as a battery or an adaptor to couple the SoC 100 to an energy source. The signal processing described herein may be adapted to and achieve power efficiency to support operation of the SoC 100 from a limited-capacity power supply 118 such as a battery. For example, operations may be performed on a portion of the SoC 100 configured for performing the operation at a lowest power consumption. As another example, operations themselves are performed in a manner that reduces an amount of computations to perform the operation, such that the algorithm is optimized for extending the operational time of a device while powered by a limited-capacity power supply 118. In some embodiments, the operations described herein may be configured based on a type of power supply 118 providing energy to the SoC 100. For example, a first set of operations may be executed to perform a function when the power supply 118 is a wall adaptor. As another example, a second set of operations may be executed to perform a function when the power supply 118 is a battery.

The SoC 100 may also include or be coupled to additional features or components that are not shown in FIG. 1. Although components are shown integrated as a single SoC 100, which may include all components built on a single semiconductor die with a common semiconductor substrate, other arrangements of the illustrated blocks different number of dies, substrates, and/or packages may be arranged to accomplish the same functionality described in this disclosure.

The memory 106 may include a non-transient or non-transitory computer readable medium storing computer-executable instructions as instructions 108 to perform all or a portion of one or more operations described in this disclosure. The instructions 108 may include a multimedia application (or other suitable application such as a messaging application) to be executed by the SoC 100 that records, processes, or outputs audio signals. The instructions 108 may also include other applications or programs executed by the SoC 100, such as an operating system and applications other than for multimedia processing.

In addition to instructions 108, the memory 106 may also store audio data. The SoC 100 may be coupled to an external memory and configured to access the memory for writing output audio files for later playback or long-term storage. For example, the SoC 100 may be coupled to a flash storage device comprising NAND memory for storing video files (e.g., MP4-container formatted files) including audio tracks and/or storing audio recordings (e.g., MPEG-1 Layer 3 files, also referred to as MP3 files). Portions of the video or audio files may be transferred to memory 106 for processing by the SoC 100, with the resulting signals after processing encoded as video or audio files in the memory 106 for transfer to the long-term storage.

While the SoC 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

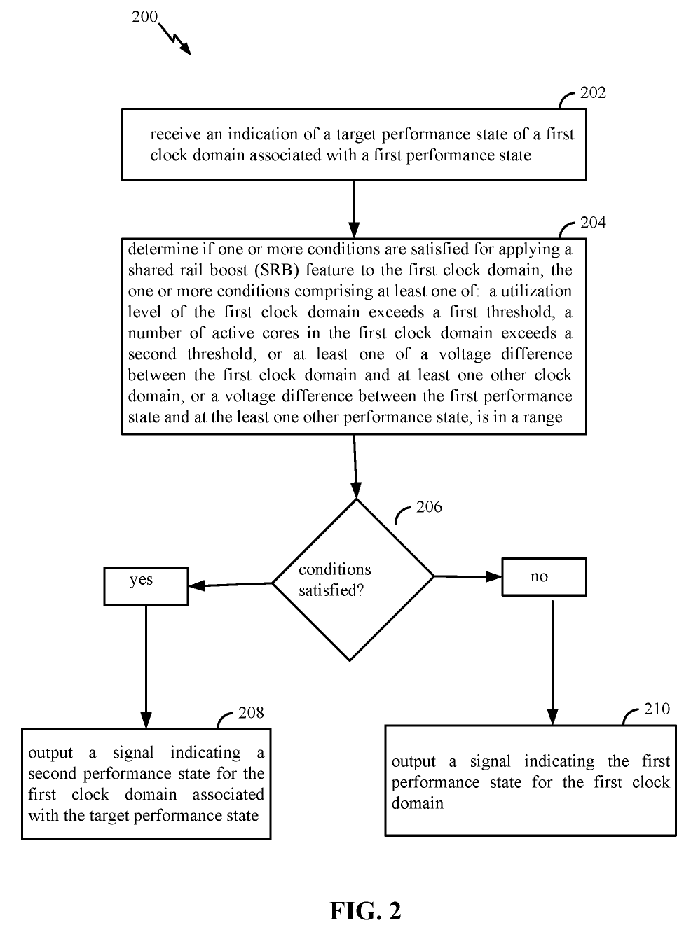

FIG. 2 shows a flowchart illustrating an example process 200 performable by or at an apparatus that supports dynamic performance management in system-on-chip (SoC) designs with multiple clock domains, as described herein. The operations of the process 200 may be implemented by an apparatus, such as a system on chip (SOC) or its components. For example, the process 200 may be performed by an apparatus or its components, such as those devices described with reference to FIG. 1, operating as or within a SOC device. In some examples, the process 200 may be performed by a SoC such as one of the SoCs described with reference to FIG. 1.

At step 202, an indication of a target performance state of a first clock domain associated with a first performance state is received. The indication may be, e.g., a vote or recommendation or the like, and may be received from various sources, such as a scheduler or a power management unit, based on the current workload and system requirements. In certain implementations, the indication is received by a Frequency Vote Aggregator (FVA) block, which aggregates indications, votes, or recommendations from different sources.

At step 204, the process determines if one or more conditions are satisfied for applying a shared rail boost (SRB) feature to the first clock domain. These conditions include: a utilization level of the first clock domain exceeding a first threshold, a number of active cores in the first clock domain exceeding a second threshold, or a voltage difference between the first clock domain and at least one other clock domain (or between the first performance state and at least one other performance state) falling within a specified range. This determination may be implemented through various mechanisms, such as comparing sensor readings or performance counters against stored threshold values, evaluating the state of control registers that reflect current system conditions, or utilizing a dedicated hardware block that continuously monitors these conditions.

Implementations of the SRB feature may consider additional factors. For instance, a SoC may not apply the SRB feature for the last active core in the domain. This consideration helps avoid unnecessary power consumption in scenarios where boosting performance would provide minimal benefit. Additionally, the apparatus may determine if the performance state of at least one other clock domain is above a certain threshold before applying the SRB feature to ensure a holistic approach to performance management across the SoC.

At step 206, the process evaluates the result of the determination made in step 204. If at least one of the conditions is satisfied, the process proceeds to step 208. If none of the conditions are satisfied, the process moves to step 210. This step serves as a decision point based on the condition evaluation performed in step 204.

At step 208, when at least one of the conditions is satisfied, the process outputs a signal indicating a second performance state for the first clock domain. The second performance state is associated with the target performance state received in step 202. This signaling may involve outputting a digital signal to a control register, generating an interrupt to a power management controller, or triggering a hardware event to initiate a state transition. In some implementations, this step may involve comparing open-loop voltages between clock domains. An SoC may select a recommended performance state based on this comparison, typically choosing a higher performance state for the clock domain with the lower open-loop voltage. This approach allows for performance improvements with minimal additional power consumption.

Determining the second performance state may involve aggregating the target performance state and the recommended performance state. The resulting second performance state may fall between the first performance state and the target performance state, thereby balancing performance needs with power efficiency considerations.

At step 210, if none of the conditions are satisfied, the process outputs a signal indicating the first performance state for the first clock domain. This ensures that the clock domain maintains its current performance state when conditions do not warrant a boost.

In certain scenarios, an SoC may need to cease application of the SRB feature after it has been applied. For example, if the first clock domain is operating at a workload lower than a threshold workload, or if the temperature of the first clock domain exceeds a temperature threshold, the SRB feature may be discontinued. This safeguard prevents thermal issues and unnecessary power consumption during light workloads. Upon such determination, the process may output a signal to revert to a previous performance state or to transition to a new state based on current system requirements.

According to certain aspects, process 200 is agnostic to schedulers or kernels. This design choice allows for greater flexibility in implementation across various SoC designs and operating systems. The performance state adjustments can be influenced by inputs from the FVA, recommended states, or hardware constraints, providing multiple avenues for fine-tuning system behavior.

By executing process 200, a SoC can optimize performance across multiple clock domains while considering characteristics of the shared power supply. As such, process 200 allows for efficient power management while maintaining the ability to boost performance when needed. The operations described with reference to steps of FIG. 2 may be performed on a digital signal processor (DSP), such as DSP 112 of the SoC 100 illustrated in FIG. 1. However, the operations may alternatively be performed by one or more of the processors of FIG. 1, including one or more of the CPU 104, the DSP 112, the GPU 126, or the NSP 124. In another example, the processor performing the operations of the steps in FIG. 2 may be dedicated logic circuitry for performing certain operations.

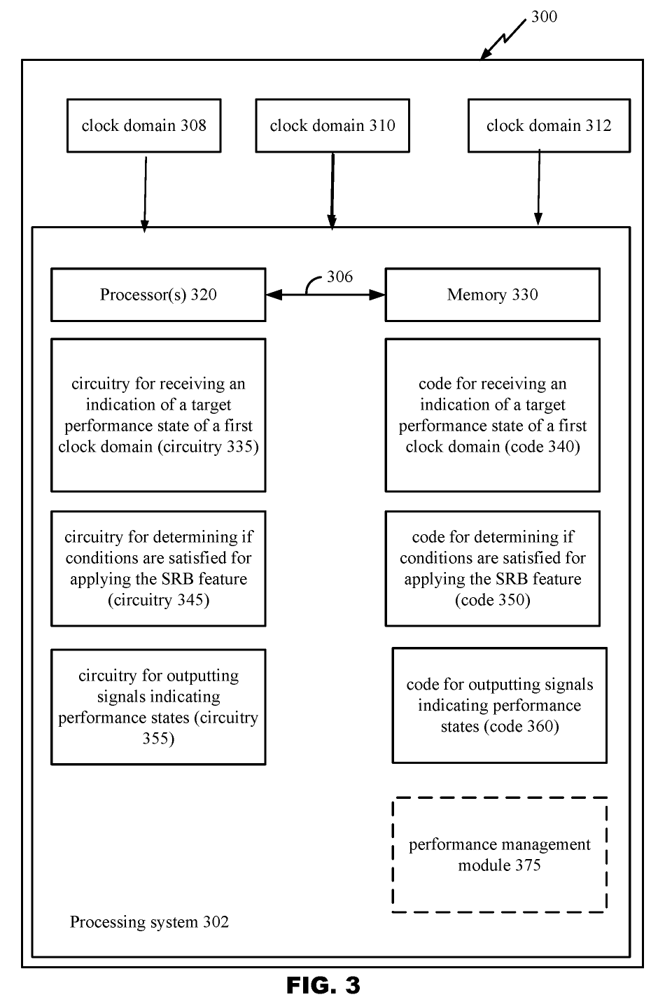

FIG. 3 is a block diagram of an example system-on-chip (SoC) apparatus 300 that supports dynamic performance management across multiple clock domains according to one or more aspects described herein. Apparatus 300 may be an example of aspects of the SoC described in the previous figures. Apparatus 300 may include various components described herein, and one or more components of apparatus 300 may include at least one processor, which may be coupled with at least one memory, to, individually or collectively, support or enable the described techniques. Each of these components may be in communication with one another (e.g., via one or more buses).

Apparatus 300 includes processing system 302 coupled to multiple clock domains 308, 310, and 312. These clock domains may operate at different frequencies and voltage levels while sharing a common power supply. Processing system 302 is configured to manage performance states across the clock domains by implementing the shared rail boost (SRB) feature and other performance optimization techniques described herein.

Processing system 302 includes one or more processors 320. In various aspects, one or more processors 320 may be representative of processors in different clock domains or a central processor managing the performance states across domains. The one or more processors 320 are coupled to computer-readable medium/memory 330 via bus 306. Computer-readable medium/memory 330 is configured to store instructions (e.g., computer-executable code, processor-executable code) that when executed by the one or more processors 320, cause the one or more processors 320 to perform method 400 described with respect to FIG. 2, or any aspect related to it.

Apparatus 300 may include circuitry for receiving an indication of a target performance state of a first clock domain (circuitry 335). This circuitry may interface with various system components to gather performance requirements and workload information. Apparatus 300 also includes, stored in computer-readable medium/memory 330, code for receiving an indication of a target performance state of a first clock domain (code 340).

Apparatus 300 may include circuitry for determining if one or more conditions are satisfied for applying the SRB feature (circuitry 345). This circuitry may assess utilization levels, active core counts, and voltage differences between domains to determine when to apply the SRB feature. Apparatus 300 also includes, stored in computer-readable medium/memory 330, code for determining if one or more conditions are satisfied for applying the SRB feature (code 350).

Apparatus 300 may include circuitry for outputting signals indicating performance states for clock domains (circuitry 355). This circuitry manages the output of signals indicating the second performance state when the conditions for applying the SRB feature are satisfied, or the first performance state when they're not. It may also handle the aggregation of target and recommended performance states. Apparatus 300 also includes, stored in computer-readable medium/memory 330, code for outputting signals indicating performance states for clock domains (code 360).

Apparatus 300 can also include performance management module 375, which may support dynamic performance optimization across multiple clock domains in accordance with examples as disclosed herein. Performance management module 375 can perform functions such as comparing open-loop voltages between domains, managing thermal thresholds, and handling special cases such as the last active core in a domain.

Apparatus 300 can operate independently of specific schedulers or kernels. As such, flexible implementation across various SoC designs is available. The performance management techniques implemented by apparatus 300 aim to optimize power efficiency while maintaining responsive performance across multiple clock domains sharing a power supply. This approach manages performance in light-weight workload scenarios and balances performance boosts with power consumption.

Various components of apparatus 300 may provide means for performing method 400 described with respect to FIG. 2, or any aspect related to it. For example, means for receiving indications or monitoring performance states may include processors 320 and circuitry 335. Means for determining if conditions are satisfied for applying the SRB feature may include processors 320 and circuitry 345. Means for outputting signals indicating performance states may include processors 320 and circuitry 355.

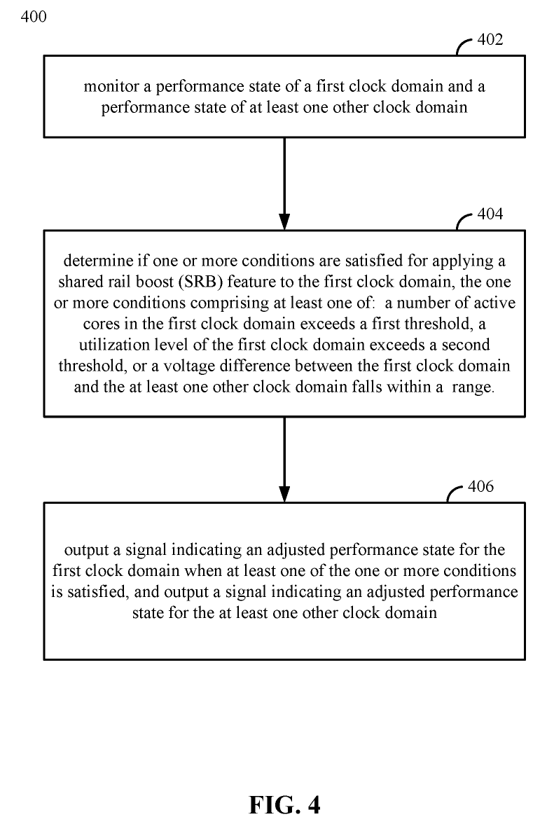

FIG. 4 shows a flowchart illustrating an example process 400 for dynamic performance management in system-on-chip (SoC) designs with multiple clock domains sharing a power supply, as described herein. The operations of process 400 may be implemented by a SoC or its components as described herein. For example, process 400 may be performed by a SoC or its components, such as those devices described with reference to FIG. 1, operating as or within a SoC device. In some examples, process 400 may be performed by a SoC such as one of the SoCs described with reference to FIG. 1.

At step 402, a performance state of a first clock domain and a performance state of at least one other clock domain are monitored. The clock domains can share a power supply. Here, monitoring involves tracking various parameters such as current frequency, voltage levels, and workload characteristics for each domain. This continuous monitoring allows for informed decisions about performance management across the shared power supply.

At step 404, the process determines if one or more conditions are satisfied for applying a shared rail boost (SRB) feature to the first clock domain. According to certain aspects, such conditions include: a number of active cores in the first clock domain exceeding a first threshold, a utilization level of the first clock domain exceeding a second threshold, or a voltage difference between the first clock domain and the at least one other clock domain falling within a specified range. In executing step 404, additional factors may be considered. For instance, open-loop voltages of the first clock domain and the at least one other clock domain might be compared. Based on this comparison, a performance state above a performance state threshold may be selected for the clock domain with the lower open-loop voltage.

At step 406, if one or more of the conditions are satisfied, the process outputs a signal indicating an adjusted performance state for the first clock domain, and outputs a signal indicating an adjusted performance state for the at least one other clock domain. This step can involve several sub-steps and considerations. One aspect can involve selecting a target performance state associated with an indication of a target performance state, which may be implemented as a software vote. Doing so ensures that the performance management takes into account the requirements communicated by the system software, maintaining responsiveness to application needs. Simultaneously, a recommended performance state is selected that is associated with the satisfied conditions for applying the SRB feature and the performance state of the at least one other clock domain. The selection can consider current conditions across monitored domains. Finally, the process can involve aggregating the target performance state and the recommended performance state to determine the adjusted performance state for the first clock domain. Here, aggregation allows the SoC to balance software requirements with hardware-based recommendations.

Process 400 can also incorporate safeguards. For instance, the SRB feature may be disabled when a temperature of the first clock domain exceeds a threshold, regardless of other conditions for applying the SRB feature. This thermal management mechanism addresses potential issues that could arise from sustained high-performance operation.

By executing process 400, a SoC can optimize performance across multiple clock domains while considering characteristics of the shared power supply. As such, process 400 allows for efficient power management while maintaining the ability to boost performance when needed. The operations described with reference to steps of FIG. 4 may be performed on a digital signal processor (DSP), such as DSP 112 of the SoC 100 illustrated in FIG. 1. However, the operations may alternatively be performed by one or more of the processors of FIG. 1, including one or more of the CPU 104, the DSP 112, the GPU 126, or the NSP 124. In another example, the processor performing the operations of the steps in FIG. 4 may be dedicated logic circuitry for performing certain operations.

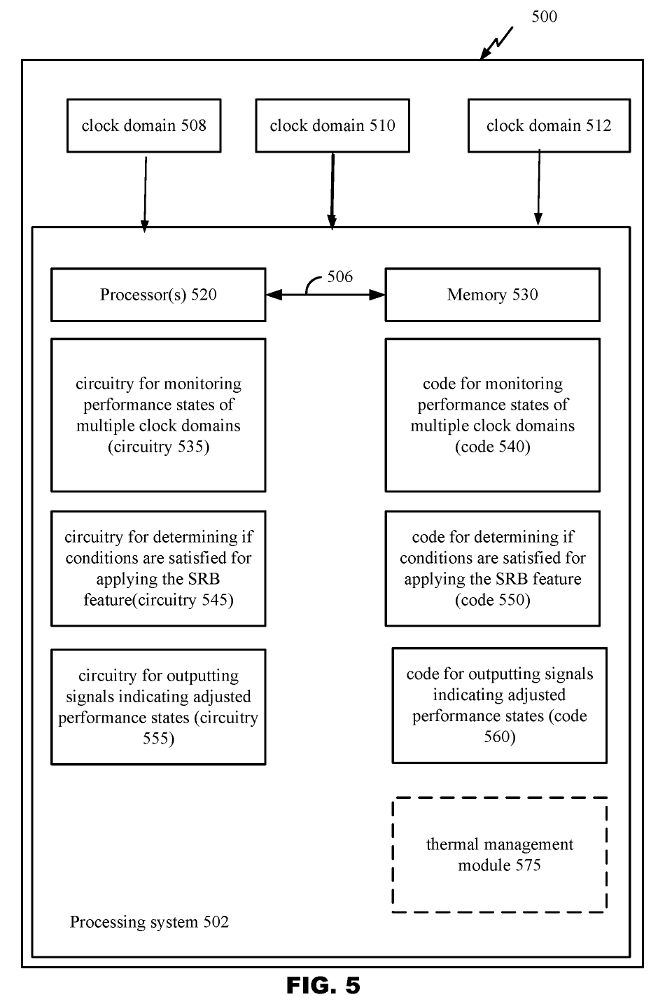

FIG. 5 is a block diagram of an example system-on-chip (SoC) apparatus 500 that supports dynamic performance management across multiple clock domains sharing a power supply, according to one or more aspects described herein. Apparatus 500 may be an example of aspects of the SoC described in FIG. 1. Apparatus 500 may include various components described herein, and one or more components of apparatus 500 may include at least one processor, which may be coupled with at least one memory, to, individually or collectively, support or enable the described techniques. Each of these components may be in communication with one another (e.g., via one or more buses).

Apparatus 500 includes processing system 502 coupled to multiple clock domains 508, 510, and 512. The clock domains can operate at potentially different frequencies and voltage levels, sharing a common power supply. Processing system 502 is configured to monitor and manage performance states across these clock domains, implementing the shared rail boost (SRB) feature and other performance optimization techniques described herein.

Processing system 502 includes one or more processors 520. In various aspects, one or more processors 520 may be representative of processors in different clock domains or a central processor managing the performance states across domains. The one or more processors 520 are coupled to computer-readable medium/memory 530 via bus 506. Computer-readable medium/memory 530 is configured to store instructions (e.g., computer-executable code, processor-executable code) that when executed by the one or more processors 520, cause the one or more processors 520 to perform method 400 described with respect to FIG. 4, or any aspect related to it.

Apparatus 500 may include circuitry for monitoring performance states of multiple clock domains (circuitry 535). This circuitry interfaces with various system components to gather real-time performance data, utilization levels, and other relevant metrics across the clock domains. Apparatus 500 also includes, stored in computer-readable medium/memory 530, code for monitoring performance states of multiple clock domains (code 540).

Apparatus 500 may include circuitry for determining if one or more conditions are satisfied for applying the SRB feature (circuitry 545). This circuitry assesses the number of active cores, utilization levels, and voltage differences between domains to determine when to apply the SRB feature. It may also compare open-loop voltages between domains for more informed decision-making. Apparatus 500 also includes, stored in computer-readable medium/memory 530, code for determining if one or more conditions are satisfied for applying the SRB feature (code 550).

Apparatus 500 may include circuitry for outputting signals indicating adjusted performance states of clock domains (circuitry 555). This circuitry manages the selection of target performance states based on indications of target performance states (which may be implemented as software votes), recommended performance states based on hardware conditions, and the aggregation of these states to determine the final adjusted performance state. Apparatus 500 also includes, stored in computer-readable medium/memory 530, code for outputting signals indicating adjusted performance states of clock domains (code 560).

Apparatus 500 can also include thermal management module 575, which supports temperature-based control of the SRB feature. This module may disable the SRB feature when temperature thresholds are exceeded, regardless of other conditions for applying the SRB feature, as described in the dependent claims. Also, performance optimization module 780 handles the task of aggregating target and recommended performance states. It may implement algorithms to balance software requirements with hardware-based recommendations, potentially leading to more efficient overall system performance.

Various components of apparatus 500 may provide means for performing method 600 described with respect to FIG. 4, or any aspect related to it. For example, means for monitoring performance states may include processors 520 and circuitry 535. Means for determining if conditions are satisfied for applying the SRB feature may include processors 520 and circuitry 545. Means for outputting signals indicating adjusted performance states may include processors 520, circuitry 555, and performance optimization module 580.

Apparatus 500 is designed to operate in a dynamic environment where workloads and performance requirements may vary across clock domains. The performance management techniques implemented by apparatus 500 aim to optimize power efficiency while maintaining responsive performance across multiple clock domains sharing a power supply. As such, apparatus 500 allows for informed control over performance states while considering characteristics of the shared power supply. By implementing the SRB feature and associated management techniques, apparatus 500 can provide performance enhancements in scenarios where beneficial, while also incorporating safeguards to prevent unnecessary power consumption or thermal issues. The ability to aggregate indications of target performance states with hardware recommendations provides a flexible framework for optimizing performance and power efficiency in complex SoC designs.

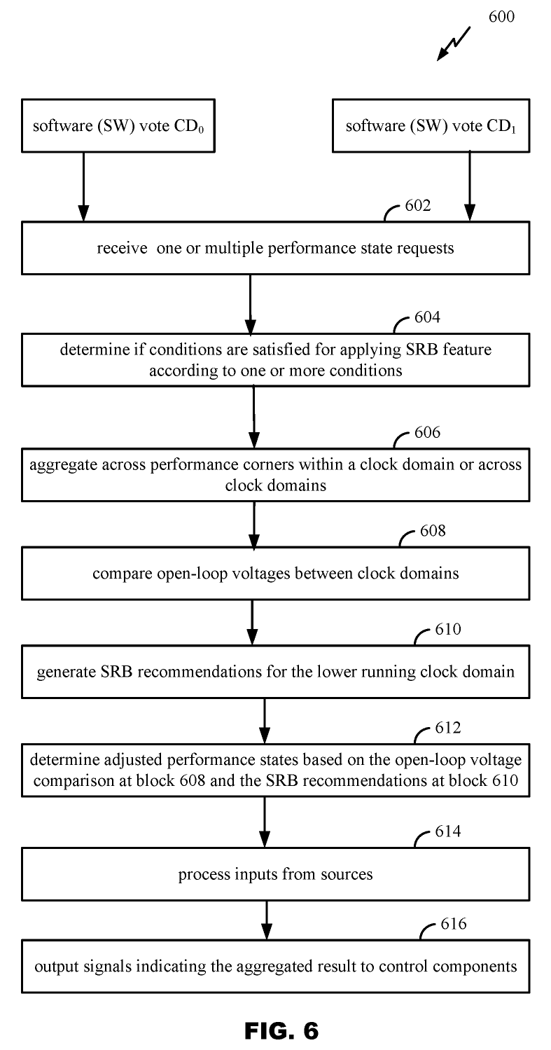

FIG. 6 illustrates a block diagram of exemplary finite state machine (FSM) logic 600 for dynamic performance management in a system-on-chip (SoC) with multiple clock domains sharing a power supply according to aspects described herein. The block diagram illustrates a decision-making process and data flow for implementing a shared rail boost (SRB) feature and managing performance states across clock domains.

At block 602, logic 600 selects or receives one or multiple performance state requests, e.g., an indication or recommendation such as software (SW) vote CD0 and/or software vote (SW) CD1. These performance state requests represent software-generated indications for desired performance states in clock domains 0 and 1, respectively, providing the initial basis for subsequent decision-making stages. A multi-input approach allows logic 600 to consider potentially conflicting performance requirements across different clock domains.

At block 604, logic 600 determines if one or more conditions are satisfied for applying the SRB feature. Logic 600 introduces flexibility by executing functions such as temperature and power based operations associated with the SRB feature. The configurability of block 604 addresses the need for adaptability in various operational scenarios, enabling the SoC to balance performance improvement with power and thermal considerations. For example, at block 604, logic 600 may determine conditions for disabling the SRB feature, e.g., when temperature thresholds are exceeded or when specific power constraints are in effect. This allows the SRB feature to be fine-tuned for different operational scenarios or disabled partially or entirely when necessary for system stability or power saving.

At block 606, if the conditions for applying the SRB feature are satisfied after block 604, logic 600 aggregates across performance corners within a clock domain or across clock domains. Here, a corner refers to a specific operating point or condition that represents a combination of various factors affecting the chip's performance. These factors can include (1) process variation, e.g., the manufacturing process can result in variations in transistor characteristics, (2) voltage, e.g., the operating voltage of the chip or a specific domain, and (3) temperature, e.g., the operating temperature of the chip. According to certain aspects, if the open-loop (OL) voltage is the same across corners, logic 600 recommends the corner that provides the best performance within the current voltage constraints. Accordingly, at block 606, logic 600 enables the SoC to make refined decisions about performance state changes within a clock domain.

At block 608, logic 600 compares open-loop voltages between clock domains, e.g., CD0 and CD1. If OL voltages differ between domains, logic 600 evaluates the trade-offs between potential performance gains and power consumption increases. If transitioning to a higher performance state in one domain would require a significant voltage increase, logic 600 may maintain the current state to avoid excessive power consumption. This comparison enables the SoC to make informed decisions about performance state changes across shared clock domains.

At block 610, logic 600 generates SRB recommendations for the lower running clock domain and, according to certain aspects, evaluates multiple conditions: (1) if the core under consideration is not the last active core in the domain, (2) if the core utilization exceeds a significant threshold (which can be determined by utilizing ARM performance monitoring unit (PMU) counters for precise measurement), and (3) if the current performance state is above a certain level or if the voltage difference between domains falls within a specified range (e.g., ±100mV). Evaluating these conditions allows logic 600 to determine when to recommend cross-domain performance state changes. For instance, logic 600 might determine that if only one core is active in a domain, applying SRB may not provide significant benefits and could unnecessarily increase power consumption. Similarly, by considering the current performance state and voltage differences, logic 600 can determine when performance boosts are truly beneficial across the shared power supply. By considering core utilization and current performance states, an SoC can avoid unnecessary performance boosts in light-weight workload scenarios, which is important for power efficiency in, e.g., mobile or battery-powered devices.

At block 612, logic 600 determines adjusted performance states based on the open-loop voltage comparison at block 608 and the SRB recommendations at block 610. For example, according to certain aspects, logic 600 may recommend a higher performance state for the clock domain with the lower open-loop voltage. This approach optimizes the performance gain relative to the potential increase in power consumption, as increasing the frequency of a domain with lower voltage typically requires less additional power than boosting a domain already at a higher voltage. If SRB recommendations are not generated based on the evaluation in block 608, logic 600 maintains the current performance states.

At block 614, logic 600 employs a vote aggregator component that processes inputs from various sources. These inputs include the initial software votes (SW votes), SRB recommendations generated in previous steps, limit recommendations (which may be based on hardware constraints or system-wide policies), and cold-temperature recommendations (which may allow for higher performance states when thermal conditions are favorable). Aggregation of such inputs allows the SoC to consider multiple factors when determining the final performance state for each clock domain.

At block 616, logic 600 outputs signals indicating the aggregated result to control components such as the Compute Subsystem (CPUSS) control processor, Power Delivery Processor (PDP), or dedicated hardware FSMs. These components interpret the aggregated recommendations and implement the actual change of performance state requests based on the decisions made through the FSM logic 600. From the foregoing, logic 600 translates the logical decisions into physical changes in clock frequencies and voltages across the SoC's domains.

By incorporating these decision points and data flows, the hardware FSM logic 600 enables more informed decisions about performance state management across multiple clock domains sharing a power supply. The FSM logic 600 addresses concerns relating to minimizing power penalties across shared clock domains, managing issues with light-weight workloads, and implementing sophisticated performance state management that considers both local and global SoC conditions.

Implementation examples are described in the following paragraphs. While some of the following implementation examples are described in terms of an example computing device memory system, further example implementations may include: the example functions of the computing device memory system discussed in the following paragraphs implemented as methods of the following implementation examples; and the example computing device memory system discussed in the following paragraphs implemented by a computing device memory system including means for performing functions of the computing device memory system of the following implementation examples.

Example 1. A method for managing performance in a system-on-chip (SoC) having multiple clock domains, including: receiving, at a processing system, an indication of a target performance state of a first clock domain associated with a first performance state; determining, by the processing system, if one or more conditions are satisfied for applying a shared rail boost (SRB) feature to the first clock domain, the one or more conditions comprising at least one of: a utilization level of the first clock domain exceeding a first threshold, a number of active cores in the first clock domain exceeding a second threshold, or at least one of a voltage difference between the first clock domain and at least one other clock domain, or a voltage difference between the first performance state and at least one other performance state, being in a specified range; and outputting, by the processing system, a signal indicating a second performance state for the first clock domain when at least one of the one or more conditions is satisfied, wherein the second performance state is associated with the target performance state.

Example 2. The method of example 1, further including: comparing an open-loop voltage of the first clock domain with an open-loop voltage of the at least one other clock domain; and selecting a recommended performance state associated with the comparison, wherein the recommended performance state comprises a higher performance state for the clock domain with the lower open-loop voltage.

Example 3. The method of example 2, further including: aggregating the target performance state and the recommended performance state to determine the second performance state, wherein the second performance state is between the first performance state and the target performance state.

Example 4. The method of any of examples 1-3, further including: disabling the SRB feature if the first clock domain is at a first workload being lower than a threshold workload, or if a temperature of the first clock domain exceeds a temperature threshold.

Example 5. The method of any of examples 1-4, wherein the receiving and determining are agnostic to at least one of schedulers or kernels.

Example 6. The method of any of examples 1-5, wherein the second performance state is associated with at least one of an input from a Frequency Vote Aggregator (FVA), the recommended performance state, or a hardware constraint.

Example 7. The method of any of examples 1-6, wherein determining if one or more conditions are satisfied for applying the SRB feature further includes: identifying the number of active cores in the first clock domain as greater than one, and not applying the SRB feature for the last active core.

Example 8. The method of any of examples 1-7, wherein determining if one or more conditions are satisfied for applying the SRB feature further includes: determining that a performance state of the at least one other clock domain is above a threshold; and applying the SRB feature if the performance state of the at least one other clock domain is above the threshold.

Example 9. An apparatus for managing performance in a system-on-chip (SoC) having multiple clock domains, including: a processing system that includes one or more processors and one or more memories coupled with the one or more processors, the processing system configured to: receive an indication of a target performance state of a first clock domain associated with a first performance state; determine if one or more conditions are satisfied for applying a shared rail boost (SRB) feature to the first clock domain, the one or more conditions comprising at least one of: a utilization level of the first clock domain exceeding a first threshold, a number of active cores in the first clock domain exceeding a second threshold, or at least one of a voltage difference between the first clock domain and at least one other clock domain, or a voltage difference between the first performance state and at least one other performance state, being in a specified range; and output a signal indicating a second performance state for the first clock domain when at least one of the one or more conditions is satisfied, wherein the second performance state is associated with the target performance state.

Example 10. The apparatus of example 9, wherein the processing system is further configured to: compare an open-loop voltage of the first clock domain with an open-loop voltage of the at least one other clock domain; and select a recommended performance state associated with the comparison, wherein the recommended performance state comprises a higher performance state for the clock domain with the lower open-loop voltage.

Example 11. The apparatus of example 10, wherein the processing system is further configured to: aggregate the target performance state and the recommended performance state to determine the second performance state, wherein the second performance state is between the first performance state and the target performance state.

Example 12. The apparatus of any of examples 9-11, wherein the processing system is further configured to: disable the SRB feature if the first clock domain is at a first workload being lower than a threshold workload, or if a temperature of the first clock domain exceeds a temperature threshold.

Example 13. The apparatus of any of examples 9-12, wherein the receiving and determining are agnostic to at least one of schedulers or kernels.

Example 14. The apparatus of any of examples 9-13, wherein the second performance state is associated with at least one of an input from a Frequency Vote Aggregator (FVA), the recommended performance state, or a hardware constraint.

Example 15. The apparatus of any of examples 9-14, wherein determining if one or more conditions are satisfied for applying the SRB feature further includes: identifying the number of active cores in the first clock domain as greater than one, and not applying the SRB feature for the last active core.

Example 16. The apparatus of any of examples 9-15, wherein determining if one or more conditions are satisfied for applying the SRB feature further includes: determining that a performance state of the at least one other clock domain is above a threshold; and applying the SRB feature if the performance state of the at least one other clock domain is above the threshold.

Example 17. An apparatus for managing performance in a system-on-chip (SoC) having more than one clock domains, including: a processing system that includes one or more processors and one or more memories coupled with the one or more processors, the processing system configured to: monitor a performance state of a first clock domain and a performance state of at least one other clock domain, wherein the first clock domain and the at least one other clock domain share a power supply; determine if one or more conditions are satisfied for applying a shared rail boost (SRB) feature to the first clock domain, the one or more conditions comprising at least one of: a number of active cores in the first clock domain exceeding a first threshold, a utilization level of the first clock domain exceeding a second threshold, or a voltage difference between the first clock domain and the at least one other clock domain being within a specified range; and output a signal indicating an adjusted performance state for the first clock domain when at least one of the one or more conditions is satisfied, and output a signal indicating an adjusted performance state for the at least one other clock domain.

Example 18. The apparatus of example 17, wherein the processing system is further configured to: compare an open-loop voltage of the first clock domain with an open-loop voltage of the at least one other clock domain; and select a performance state above a performance state threshold for the clock domain with the lower open-loop voltage.

Example 19. The apparatus of any of examples 17-18, wherein the processing system is further configured to: disable the SRB feature when a temperature of the first clock domain exceeds a temperature threshold regardless of the conditions for applying the SRB feature.

Example 20. The apparatus of any of examples 17-19, wherein outputting the signal indicating the adjusted performance state for the first clock domain includes: selecting a target performance state associated with a target performance indication; selecting a recommended performance state associated with the satisfied conditions for applying the SRB feature and the performance state of the at least one other clock domain; and aggregating the target performance state and the recommended performance state to determine the adjusted performance state for the first clock domain.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system’s registers and memories into other data similarly represented as physical quantities within the computer system’s registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to one or more Figures may be combined with one or more blocks (or operations) described with reference to another of the Figures. For example, one or more blocks (or operations) of FIG. 2 may be combined with one or more blocks (or operations) of FIG. 4. As another example, one or more blocks associated with FIG. 4 may be combined with one or more blocks (or operations) associated with FIG. 6.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc wherein disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes .1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method for managing performance in a system-on-chip (SoC) having multiple clock domains, the method comprising:
receiving an indication of a target performance state of a first clock domain associated with a first performance state;
determining if one or more conditions are satisfied for applying a shared rail boost (SRB) feature to the first clock domain, the one or more conditions comprising at least one of: a utilization level of the first clock domain exceeding a first threshold, a number of active cores in the first clock domain exceeding a second threshold, or at least one of a voltage difference between the first clock domain and at least one other clock domain, or a voltage difference between the first performance state and at least one other performance state, being in a specified range; and
outputting a signal indicating a second performance state for the first clock domain when at least one of the one or more conditions is satisfied, wherein the second performance state is associated with the target performance state.

2. The method of claim 1, further comprising:
comparing an open-loop voltage of the first clock domain with an open-loop voltage of the at least one other clock domain; and
selecting a recommended performance state associated with the comparison, wherein the recommended performance state comprises a higher performance state for the clock domain with the lower open-loop voltage.

3. The method of claim 2, further comprising:
aggregating the target performance state and the recommended performance state to determine the second performance state, wherein the second performance state is between the first performance state and the target performance state.

4. The method of claim 1, further comprising:
disabling the SRB feature if the first clock domain is at a first workload being lower than a threshold workload, or if a temperature of the first clock domain exceeds a temperature threshold.

5. The method of claim 1, wherein the receiving and determining are agnostic to at least one of schedulers or kernels.

6. The method of claim 1, wherein the second performance state is associated with at least one of an input from a Frequency Vote Aggregator (FVA), the recommended performance state, or a hardware constraint.

7. The method of claim 1, wherein determining if one or more conditions are satisfied for applying the SRB feature further comprises:
identifying the number of active cores in the first clock domain as greater than one, and not applying the SRB feature for the last active core.

8. The method of claim 1, wherein determining if one or more conditions are satisfied for applying the SRB feature further comprises:
determining that a performance state of the at least one other clock domain is above a threshold; and
applying the SRB feature if the performance state of the at least one other clock domain is above the threshold.

9. An apparatus for managing performance in a system-on-chip (SoC) having multiple clock domains, comprising:
a processing system that includes one or more processors and one or more memories coupled with the one or more processors, the processing system configured to cause the apparatus to:
receive an indication of a target performance state of a first clock domain associated with a first performance state;
determine if one or more conditions are satisfied for applying a shared rail boost (SRB) feature to the first clock domain, the one or more conditions comprising at least one of: a utilization level of the first clock domain exceeding a first threshold, a number of active cores in the first clock domain exceeding a second threshold, or at least one of a voltage difference between the first clock domain and at least one other clock domain, or a voltage difference between the first performance state and at least one other performance state, being in a specified range; and
output a signal indicating a second performance state for the first clock domain when at least one of the one or more conditions is satisfied, wherein the second performance state is associated with the target performance state.

10. The apparatus of claim 9, wherein the processing system is further configured to cause the apparatus to:
compare an open-loop voltage of the first clock domain with an open-loop voltage of the at least one other clock domain; and
select a recommended performance state associated with the comparison, wherein the recommended performance state comprises a higher performance state for the clock domain with the lower open-loop voltage.

11. The apparatus of claim 10, wherein the processing system is further configured to cause the apparatus to:
aggregate the target performance state and the recommended performance state to determine the second performance state, wherein the second performance state is between the first performance state and the target performance state.

12. The apparatus of claim 9, wherein the processing system is further configured to cause the apparatus to:
disable the SRB feature if the first clock domain is at a first workload being lower than a threshold workload, or if a temperature of the first clock domain exceeds a temperature threshold.

13. The apparatus of claim 9, wherein the receiving and determining are agnostic to at least one of schedulers or kernels.

14. The apparatus of claim 9, wherein the second performance state is associated with at least one of an input from a Frequency Vote Aggregator (FVA), the recommended performance state, or a hardware constraint.

15. The apparatus of claim 9, wherein determining if one or more conditions are satisfied for applying the SRB feature further comprises:
identifying the number of active cores in the first clock domain as greater than one, and not applying the SRB feature for the last active core.

16. The apparatus of claim 9, wherein determining if one or more conditions are satisfied for applying the SRB feature further comprises:
determining that a performance state of the at least one other clock domain is above a threshold; and
applying the SRB feature if the performance state of the at least one other clock domain is above the threshold.

17. An apparatus for managing performance in a system-on-chip (SoC) having more than one clock domains, comprising:
a processing system that includes one or more processors and one or more memories coupled with the one or more processors, the processing system configured to cause the apparatus to:
monitor a performance state of a first clock domain and a performance state of at least one other clock domain, wherein the first clock domain and the at least one other clock domain share a power supply;
determine if one or more conditions are satisfied for applying a shared rail boost (SRB) feature to the first clock domain, the one or more conditions comprising at least one of: a number of active cores in the first clock domain exceeding a first threshold, a utilization level of the first clock domain exceeding a second threshold, or a voltage difference between the first clock domain and the at least one other clock domain being within a specified range; and
output a signal indicating an adjusted performance state for the first clock domain when at least one of the one or more conditions is satisfied, and output a signal indicating an adjusted performance state for the at least one other clock domain.

18. The apparatus of claim 17, wherein the processing system is further configured to cause the apparatus to:
compare an open-loop voltage of the first clock domain with an open-loop voltage of the at least one other clock domain; and
select a performance state above a performance state threshold for the clock domain with the lower open-loop voltage.

19. The apparatus of claim 17, wherein the processing system is further configured to cause the apparatus to:
disable the SRB feature when a temperature of the first clock domain exceeds a temperature threshold regardless of the conditions for applying the SRB feature.

20. The apparatus of claim 17, wherein outputting the signal indicating the adjusted performance state for the first clock domain comprises:
selecting a target performance state associated with a target performance indication;
selecting a recommended performance state associated with the satisfied conditions for applying the SRB feature and the performance state of the at least one other clock domain; and
aggregating the target performance state and the recommended performance state to determine the adjusted performance state for the first clock domain.
